(19) United States
(12) Patent Application Publication
(10) Pub. No.: US 2006/0227891 A1
(43) Pub. Date: Oct. 12, 2006

(54) Method of channel estimation for MIMO-OFDM using phase rotated low overhead preamble

(75) Inventors: Huaning Niu, Santa Clara, CA (US); Chiu Ngo, San Francisco, CA (US)

Correspondence Address: Kenneth L. Sherman, Esq.;Myers Dawes Andras & Sherman, LLP, 19900 MacArthur Blvd. 11th Floor, Irvine, CA, 92612, US

(73) Assignee: Samsung Electronics Co., Ltd., Suwon City (KR)

(21) Appl. No.: 11/101,963

(22) Filed: Apr. 7, 2005

(51) Int. Cl. H04B 7/02; H04J 11/00

(52) U.S. Cl. 375/267; 370/208

(57) ABSTRACT

A low overhead long preamble and the corresponding channel estimator for MIMO-OFDM systems that are backward compatible with current 802.11a systems. The preamble has a first training sequence and a second training sequence, wherein the second training sequence is a phase rotation of the first training sequence. The first training sequence comprises a 802.11a training sequence. The preamble can further include multiple training sequences, wherein each training sequence is a different phase rotation of the first training sequence.

### FIELD OF THE INVENTION

The present invention relates generally to data communication, and more particularly, to data communication with transmission diversity using Orthogonal Frequency Division Multiplexing (OFDM) in multiple antenna channels.

### BACKGROUND OF THE INVENTION

In wireless communication systems, antenna diversity plays an important role in increasing the system link robustness. OFDM is used as a modulation technique for transmitting digital data using radio frequency signals (RF). In OFDM, a radio signal is divided into multiple sub-signals that are transmitted simultaneously at different frequencies to a receiver. Each sub-signal travels within its own unique frequency range (sub-channel), which is modulated by the data. OFDM distributes the data over multiple channels, spaced apart at different frequencies. Multiple input multiple output (MIMO) OFDM systems in rich scattering wireless channels have been shown to have enormous capacity and are considered for the high-throughput WLAN standard.

For example, a typical MIMO system can have Nₜ transmitter antennas and Nᵣ receiver antennas, requiring estimation of NₜNᵣ channels. Coherent detection in a MIMO-OFDM system requires channel state information (CSI), which is essential to its detection performance. A good estimate of CSI can be obtained through a careful design of long preamble (long training sequence).

An optimal preamble design criterion is provided by E. G. Larsson and J. Li, “Preamble design for multiple-antenna OFDM based WLANs with Null subcarriers,” IEEE Signal Processing Letters, Vol. 8, No. 11, November 2001, pp. 285-288 (incorporated herein by reference). Referring to the example in FIG. 1, such an optimal preamble design can be implemented using time multiplexing (Time Orthogonal) for a 4-antenna (Nₜ=4) MIMO-OFDM system (i.e., the first antenna transmits an 802.11a preamble while the other 3 antennas are idle). Each preamble A1-A4 is the same as the legacy 802.11a preamble. However, a shortcoming of such a method is that it incurs large overhead, and presents practical problems such as power amplifier non-linearity.

A low overhead design using frequency multiplexing (Frequency Orthogonal) is provided by I. Tolochko and M. Faulkner, “Low overhead pilot structures,” IEEE 802.11-04-0020-00-00n, Victoria University (incorporated herein by reference). FIG. 2 shows an example implementation of such a Frequency Orthogonal method for a 4-antenna MIMO-OFDM system. However, this low overhead design has several shortcomings, including: requiring more complicated minimum mean square error (MMSE) interpolation algorithm in frequency domain; not being scalable (i.e., adding one new antenna requires the preamble changes to every transmitter antenna); requiring further investigation on fine carrier frequency offset (CFO) estimation, etc.

### BRIEF SUMMARY OF THE INVENTION

The present invention addresses the shortcomings. In one embodiment the present invention provides a low overhead long preamble and the corresponding channel estimator for MIMO-OFDM systems that are backward compatible with current 802.11a systems.

In one embodiment the present invention provides a preamble for a wireless communications system, the preamble comprising: a first training sequence; and a second training sequence, wherein the second training sequence comprises a phase rotation of the first training sequence. The first training sequence comprises a 802.11a training sequence. The preamble can further comprise multiple training sequences, wherein each training sequence comprises a different phase rotation of the first training sequence.

Preferably, the wireless communication system comprises an orthogonal frequency division multiplexing (OFDM) multiple input multiple output (MIMO) system having a transmitter with multiple antennas, such that the preamble is transmitted over a plurality of sub-carriers by multiple transmitter antennas, wherein each training sequence of the preamble is transmitted over a different one of the multiple antennas.

In another aspect the present invention provides a method of transmitting a data signal over a wireless communication system, comprising the steps of: providing a preamble for the data signal, the preamble including a first training sequence, and a second training sequence, wherein the second training sequence comprises a phase rotation of the first training sequence; configuring the preamble for transmission over a plurality of sub-carriers by multiple transmitter antennas; and transmitting the preamble over the multiple transmitter antennas.

Yet in another aspect, the present invention provides a method of channel estimation in a wireless OFDM-MIMO receiver, comprising the steps of: receiving a data signal including one or more preambles from a transmitter, each preamble comprising a first training sequence, and a second training sequence, wherein the second training sequence comprises a phase rotation of the first training sequence; and estimating the channel from the received preambles using a bank of linear filters.

As such, the present invention provides a low overhead long preamble and the corresponding channel estimator for MIMO-OFDM systems that are backward compatible with current 802.11a systems. It provides simple scalability to multiple transmit antennas (e.g., 4 antennas). Further, simple fine synchronization as in 802.11a can be used.

These and other features, aspects and advantages of the present invention will become understood with reference to the following description, appended claims and accompanying figures.

### BRIEF DESCRIPTION OF THE DRAWINGS

FIG. 1 shows a conventional preamble design using time multiplexing.

FIG. 2 shows a conventional preamble design using frequency multiplexing.

FIG. 3 shows an example block diagram of a wireless transmission system including a MIMO-OFDM transmitter and receiver according to an embodiment of the present invention.

FIG. 4 shows an example block diagram of channel estimation using a linear filter bank implemented in the system of FIG. 3.

FIG. 5 shows an example MSE comparison of different preamble designs with 2 transmitter antennas over 802.11n channel model B.

### DETAILED DESCRIPTION OF THE INVENTION

Multiple input multiple output (MIMO) orthogonal frequency division multiplexing (OFDM) systems in rich scattering wireless channels have been shown to have enormous capacity and are considered for the high-throughput WLAN standard. Coherent detection in MIMO-OFDM system requires channel state information (CSI), which is essential to its detection performance. Good estimates of CSI can be obtained through a careful design of long preamble (long training sequence). In one embodiment, the present invention provides a low overhead long preamble and the corresponding channel estimator for MIMO-OFDM systems that are backward compatible with current 802.11a systems.

Typically an OFDM system includes a transmitter (TX) and a receiver (RX). The transmitter comprises a sub-channel modulator, an IFFT input packer, a diversity encoder, an IFFT block, a Filter/Digital-to-Analog-Converters (Filter/DAC), an RF modulator block and an antenna. The filter for “Filter/DAC” is for interpolation (up-sampling) whereas the filter for “ADC/filter” is for decimation (down-sampling).

Typically, an OFDM receiver comprises an antenna, an RF demodulator, an Analog-to-Digital-Converter/Filter (ADC/Filter), an FFT block, a diversity combiner/decoder and a sub-channel demodulator. The received OFDM signals are converted from time-domain data to frequency-domain data by the FFT blocks, where FFT is performed on each symbol to convert the time-domain into frequency-domain. The frequency-domain data is then decoded by diversity combiner/decoder that examines the phase and amplitude of the sub-channels. The FFT process extracts the phase and amplitude of each received sub-channel from the received samples, and the diversity combiner provides receive diversity in the frequency domain.

An OFDM-MIMO system includes multiple IFFT blocks, Filters/DACs, RF blocks and antennas. In an OFDM-MIMO system, OFDM symbols are transmitted using multiple antennas, concurrently transmitting the symbols over the same sub-carriers to multiple receiver antennas. When the signals are detected by the multiple antennas, they must be synchronized and framed properly to avoid errors. One or more preambles are inserted between the OFDM data symbols within OFDM frames in the time domain. The preamble includes training symbols which include a training sequence for different antennas (also known as pilot carrier symbols). The signal is formatted as a plurality of frames, each having multiple slots, wherein the first slot in each frame includes a preamble and subsequent slots include data/pilot symbols. The preamble comprises two training symbols (sequences). The short training sequence is used for timing detection, automatic gain control (AGC) and coarse frequency offset estimation, etc. The long training sequence is used for fine synchronization and channel estimation. In one aspect, the present invention provides a long training sequence design.

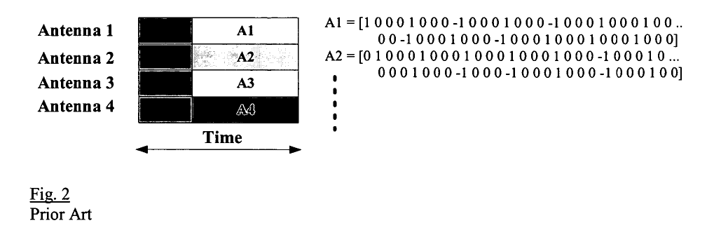

The preamble is broadcast by the transmitter with multiple (e.g., 2) antennas, wherein each transmits respective pairs of identical training symbols at a sub-carrier frequency. The sub-carrier frequencies are divided into groups which are each assigned to a respective transmitter antenna. The training sequences for each antenna are orthogonal in the frequency domain in an interlaced transmission patterns, and the training sequences are superimposed in the time domain (e.g., FIG. 2).

An OFDM packet based receiver includes a synchronization function that receives the base band OFDM signal and uses the preamble of the incoming packet to perform synchronization including symbol timing and frequency offset estimation.

Phase Rotated Low Overhead Preamble

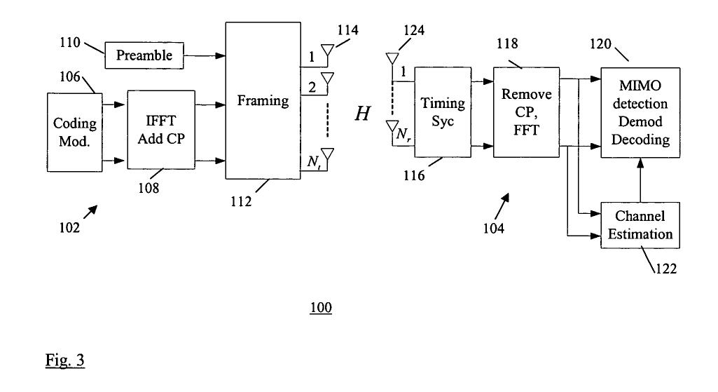

Referring to FIG. 3, an example block diagram of an embodiment of packet based MIMO-OFDM system 100 including a transmitter (TX) 102 and a receiver (RX) 104, according to the present invention is shown. The transmitter 102 comprises a Coding Modulator 106, an IFFT Add CP processor (IFFT/ADD CP) 108, a Preamble generator 110, a Framing processor 112 and multiple transmit antennas 114 (e.g., 1 through Nₜ).

The Coding/Modulator 106 inputs information bits, then codes the information bits by particular error correction codes including convolutional codes, turbo codes, low-density parity-check codes, etc., and maps the coded bits into QAM symbols, outputting transmitted QAM symbols. The IFFT/ADD CP 108 inputs the modulated QAM symbols, from the vector of QAM symbols forms an OFDM symbol, applies IFFT to convert the frequency domain OFDM symbol to time domain, adds cyclic prefix to the time-domain OFDM symbol for transmission, and outputs time-domain OFDM symbols. The Preamble generator 110 outputs the pre-designed preamble sequence. The Framing processor 112 inputs time domain OFDM symbols and the preamble sequence, forms a packet which has multiple time slots wherein the first several slots contain the preamble sequence and the remaining slots contain OFDM symbols, and outputs a data packet to be transmitted

The receiver 104 comprises a Timing Sync processor 116, a Remove CP FFT processor 118, a MIMO Detection Demod Decoding processor 120, a Channel Estimator and 122 multiple receive antennas 124 (e.g., 1 through Nᵣ).

The Timing Sync processor 116 receives the base band OFDM signal and uses the preamble of the incoming packet to perform synchronization including symbol timing and frequency offset estimation. Specifically, the Timing/Sync processor 116 inputs the received time-domain signal, performs timing detection, coarse and fine frequency offset estimation and compensation, and outputs time-domain OFDM symbols. The Remove CP/FFT 104 inputs the time-domain OFDM symbols, removes the cyclic prefix, performs FFT to convert the time-domain OFDM symbols back to frequency-domain OFDM symbol for further processing, and outputs frequency domain received OFDM symbols. The MIMO detection Demod Decoding 120 inputs the frequency domain OFDM symbols and the estimated CSI, performs MIMO detection on each sub-channel which separates different data streams that are transmitted from different antennas, de-maps the signal to obtain the information of the coded bits, decodes the coded bits to obtain the transmitted information bits, and outputs information bits. The Channel Estimator 122 inputs the frequency domain received preamble sequence, applies a linear filter bank on the received preamble, and outputs the estimated CSI.

In the MIMO-OFDM system 100 of FIG. 3, channel estimation is performed in the frequency domain after the FFT operation. Channel estimation in frequency domain is less complicated than in time-domain. In frequency domain, the received preamble is a product of the transmitted preamble and the channel, while in time domain, it is convolution. As noted, the system 100 in FIG. 3 comprises Nₜ transmitter antennas and Nᵣ receiver antennas (with a channel matrix H), which requires estimation of NₜNᵣ channels.

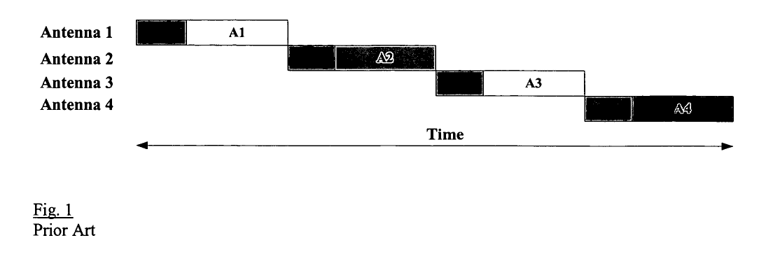

According to the present invention, a phase rotated 802.11a sequence is used for the long preamble design for MIMO-OFDM systems such as the system 100. An example implementation is described below for a 2 antenna transmitter/receiver (Nₜ=2, Nᵣ=2) according to the present invention. In this example, the long training sequence X₁ transmitted from the first antenna 114 (T×1) is the legacy 802.11a preamble, and the second training sequence X₂=X₁e^{jπ}, wherein the second training sequence X₂ is a phase rotation of X₁ according to the present invention. The values X₁, X₂, etc., according to the present invention are different than those of the preamble values A1, A2, etc., in the prior art shown in FIGS. 1-2.

Other phase rotations are also possible. For example in a two-transmitter antenna system, the phase rotation can be any value between π/2 to 3π/2 (i.e., 90 degree to 270 degrees). Other examples are possible.

Accordingly, example transmitter training sequences are:
First antenna 114 (T×1):
   X₁=[1 1 −1 −1 1 1 −1 1 −1 1 1 1 1 1 1 −1 −1 1 1 −1 1 −1 1 1 1 1 1 −1 −1 1 1 −1 1 −1 1 −1 −1 −1 −1 −1 1 1 −1 −1 1 −1 1 −1 1 1 1 1]
Second antenna 114 (T×2):
   X₂=[−1 1 1 −1 −1 1 1 1 1 1 −1 1 −1 1 −1 −1 1 1 −1 −1 −1 −1 −1 1 −1 1 −1 −1 1 1 −1 −1 −1 −1 −1 −1 1 −1 1 −1 −1 1 1 −1 −1 −1 −1 −1 −1 1 −1 1]

X₁ is as that in 802.11a to provide backward compatibility. For the example 2-antenna MIMO-OFDM system according to the present invention, X₂ is a phase (frequency) rotation of X₁ (i.e., X₂=X₁e^{jπ}, where j=\sqrt{−1}).

The preamble design according to the present invention can be easily extended to e.g. Nₜ=4 antennas, wherein X_{3 l =X}₁e^{jπ/2} and X₄=X₁e^{j3π/2}. The relative phase rotation is 90 degrees. For example, in a four-transmitter antenna system, the evenly distributed phase rotation (i.e., 0, 90, 180, 270) for each antenna provides the best performance. Smaller phase rotation is possible if the channel delay spread is short. All sequences transmit simultaneously from all antennas with power 1/Nt. For the example 4 antenna MIMO-OFDM system according to the present invention, X₃, X₄ are phase rotations of X1 (i.e., X₃=X₁e^{jπ/2} and X₄=X₁e^{j3π/2}). As those skilled in the art will appreciate, the phase rotation according to the present invention can be utilized with MIMO-OFDM systems having more than 4 antennas by combining with the other orthogonal designs such as time orthogonal, frequency orthogonal and code orthogonal, etc. As such, the present invention is not limited to the examples provided herein.

Phase rotation according to the present invention provides accurate channel estimation for at least the following reasons. From a frequency domain viewpoint, the channel response of the original 802.11a long training sequence is a low pass sequence. By applying phase rotation according to the present invention, the channel response of the phase rotated sequence, which is transmitted on the second antenna, becomes a high-pass sequence. Therefore, when applying a low-pass filter bank, the CSI can be properly separated from the first antenna and second antenna. From the time domain viewpoint, frequency domain phase rotation results in the time domain delay. When the delay is longer than the time-domain channel response, phase rotation according to the present invention allows filtering out the first and second antenna CSI properly.

Channel Estimation

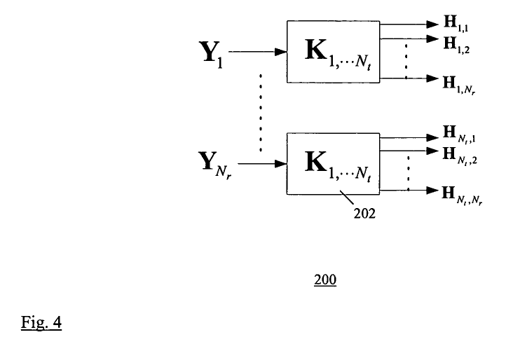

In conjunction with the novel training sequences using phase rotation on X₁, the present invention further provides a novel channel estimation method e.g. in the Channel Estimator 122 of the receiver 104 (FIG. 3). As shown by example in FIG. 4, the NₜNᵣ channels can be estimated from the received preamble signals using a bank 200 of linear filters 202 in the Channel Estimator 122. In the filter 200 of FIG. 4, Kᵢ represent the filter coefficients, and the received symbols Yᵢ are passed through the filter 200 according to the coefficient Kᵢ to obtain channel estimation.

The system model of the example filter bank 200 in FIG. 4 is according to relation (1):

$${Y}_{j} = {\sum }_{i = 1}^{{N}_{t}} {X}_{i} {H}_{ij} + {W}_{j} , j = 1 , 2 , … , {N}_{r} \qquad ( 1 )$$

wherein Xᵢ is the N×1 preamble vector from the i^{th} transmitter antenna where N is the number of OFDM data-subcarriers, Yⱼ is the received N×1 vector at the j^{th} receiver antenna, Hᵢⱼ is the channel response in frequency domain from i^{th} transmitter antenna to j^{th} receiver antenna, and Wⱼ is the Additive White Gaussian Noise (AWGN) vector.

The Hᵢⱼ channel response is estimated from Yⱼ, using linear filter Kᵢⱼ 202, i.e., Ĥᵢⱼ=KᵢⱼYⱼ. The Linear Minimum Mean Square Error (LMMSE) estimator Kᵢⱼ can be derived from the well-known orthogonal principle according to relation (2):

$$\begin{matrix}E [ ( { {H}^{⋒}}_{ij} - {H}_{ ij} ) {Y}_{ j}^{ H} ] = E [ {K}_{ij} {Y}_{j} {Y}_{J}^{H} - {H}_{ij} {Y}_{j}^{H} ] \\ = {K}_{ij} {R}_{YY} - {R}_{{H}_{i} Y} \\ = 0\end{matrix} \qquad ( 2 )$$

wherein R_{YY} is the autocorrelation matrix and R_{H}_{ᵢ}_{Y} is the cross-correlation matrix, and E[] performs an expectation operation.

When the channel is correlated, computation of the autocorrelation matrix R_{YY} and the cross-correlation matrix R_{H}_{ᵢ}_{Y} results in complicated filter design. In order to obtain a simpler LMMSE filter, it is assumed that the channel is spatially uncorrelated. In that case, the linear MMSE filter coefficients are according to relation (3) below:

$${K}_{i} = {R}_{{H}_{i} Y} {R}_{YY}^{- 1} = {R}_{{H}_{i} {H}_{i}} {{X}_{i}^{H} ( {\sum }_{l = 1}^{{N}_{t}} {X}_{l} {R}_{{H}_{l} {H}_{l}} {X}_{l}^{H} + {σ}_{W}^{2} I )}^{- 1} \qquad ( 3 )$$

where Kᵢⱼ=Kᵢ, j=1, . . . N, is the filter coefficient for the i^{th} transmitter antenna, σ_{W}² is the noise variance, W is the Gaussian noise vector, I is identity matrix., R_{H}_{ᵢ}_{H}_{ᵢ} is the auto-correlation of the channel response vector Hᵢ from the i^{th} antenna, and R_{H}_{ₗ}_{H}_{ₗ} is the auto-correlation of the channel response vector Hₗ from the 1^{th} antenna. Relation (3) above represents the linear filter coefficients, and is derived (approximated) according to the present invention from relation (2).

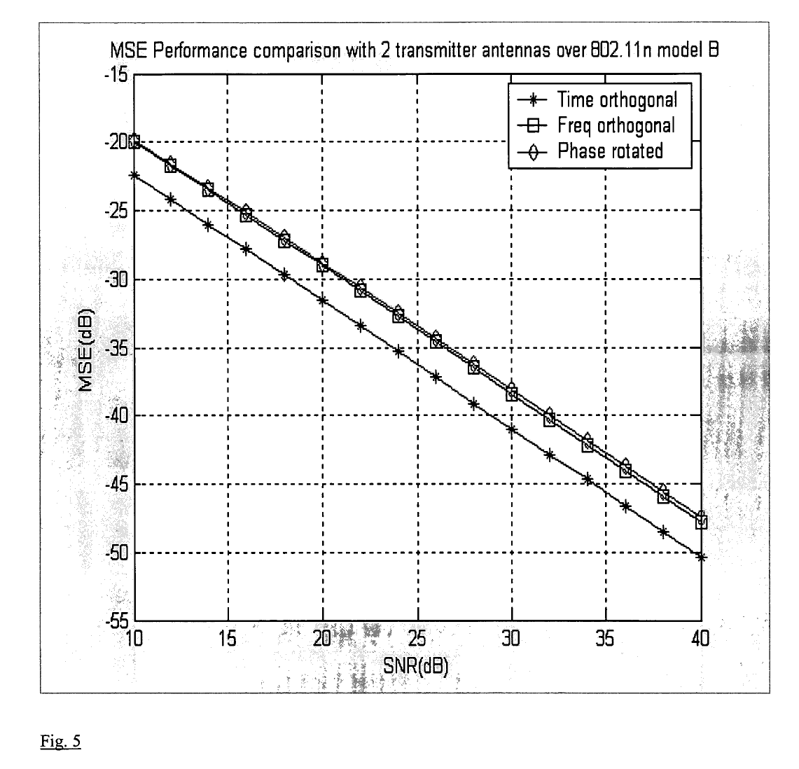

FIG. 5 shows an example performance comparison between a phase-shifted low overhead preamble technique (Phase Rotated) according to the present invention and the prior art Time Orthogonal and Frequency Orthogonal methods, in a spatially correlated fading channel. The present invention provides more flexibility than the prior art while maintaining the same performance. Compared to a Time multiplexing method, a Phase Rotation method according to the present invention uses a shorter preamble. Further, compared to a Frequency Orthogonal method, a Phase Rotation method according to the present invention allows fine frequency synchronization. Further, the performance loss due to the uncorrelated scattering approximation in the present invention is negligible.

The low overhead preamble scheme according to the present invention provides virtually optimal estimation performance when the number of transmitted antennas is preferably less than or equal to 4. When higher number of transmitter antennas is used, as those skilled in the art will appreciate, the phase rotated preamble scheme according to the present invention can be combined with time multiplexing for channel estimation. For example, in an eight-transmitter antenna system, transmission on antennas 1-4 is using the phase rotated preamble in the first time-slot, then transmit on antenna 5-8 using the phase rotated preamble (same as the antenna 1-4 respectively) in the second time slot. In this way, we can estimate the CSI from all the 8 transmit antennas.

As such, the present invention provides a low overhead long preamble and the corresponding channel estimator for MIMO-OFDM systems that are backward compatible with current 802.11a systems. It provides simple scalability to multiple transmit antennas (e.g., 4 antennas). Further, simple fine synchronization as in 802.11a can be used.

The present invention has been described in considerable detail with reference to certain preferred versions thereof; however, other versions are possible. Therefore, the spirit and scope of the appended claims should not be limited to the description of the preferred versions contained herein.

What is claimed is:

1. A preamble for a wireless communications system, the preamble comprising:
a first training sequence; and
a second training sequence, wherein the second training sequence comprises a phase rotation of the first training sequence.

2. The preamble of claim 1 wherein the first training sequence comprises a 802.11a training sequence.

3. The preamble of claim 1 wherein the second training sequence X₂ comprises a phase rotation of the first training sequence X₁ according to the relation: X₂=X₁e^{jπ}.

4. The preamble of claim 1 further comprising multiple training sequences, wherein each training sequence comprises a different phase rotation of the first training sequence.

5. The preamble of claim 4 wherein:
the second training sequence X₂ comprises a phase rotation of the first training sequence X₁ according to the relation: X₂=X₁e^{jπ};
a third training sequence X₃ comprises a phase rotation of the first training sequence X₁ according to the relation: X₃=X₁e^{jπ/2}; and
a fourth training sequence X₄ comprises a phase rotation of the first training sequence X₁ according to the relation: X₄=X₁e^{j3π/2}.

6. The preamble of claim 1 wherein the wireless communication system comprises an orthogonal frequency division multiplexing (OFDM) system.

7. The preamble of claim 1 wherein the wireless communication system comprises an orthogonal frequency division multiplexing (OFDM) multiple input multiple output (MIMO) system.

8. The preamble of claim 1 wherein the wireless communication system includes a transmitter such that the preamble is transmitted over a plurality of sub-carriers by multiple transmitter antennas.

9. The preamble of claim 8 wherein the first training sequence is transmitted over a first antenna, and the second training sequence is transmitted over a second antenna.

10. The preamble of claim 1 wherein the wireless communication system comprises an orthogonal frequency division multiplexing (OFDM) multiple input multiple output (MIMO) system having a transmitter with multiple antennas, such that the preamble is transmitted over a plurality of sub-carriers by multiple transmitter antennas, wherein each training sequence of the preamble is transmitted over a different one of the multiple antennas.

11. A method of transmitting a data signal over a wireless communication system, comprising the steps of:
providing a preamble for the data signal, the preamble including a first training sequence, and a second training sequence, wherein the second training sequence comprises a phase rotation of the first training sequence;
configuring the preamble for transmission over a plurality of sub-carriers by multiple transmitter antennas; and
transmitting the preamble over the multiple transmitter antennas.

12. The method of claim 11 wherein said data signal comprises an Orthogonal Frequency Division Multiplexing (OFDM) signal.

13. The method of claim 11 wherein said data signal comprises a plurality of frames, each frame including a plurality of time slots, each time slot including a plurality of symbols, wherein one or more preambles are inserted between the symbols within the frames in the time domain.

14. The method of claim 11 wherein the first training sequence comprises a 802.11a training sequence.

15. The method of claim 11 wherein the second training sequence X₂ comprises a phase rotation of the first training sequence X₁ according to the relation: X₂=X₁e^{jπ}.

16. The method of claim 11 where in the preamble further comprises multiple training sequences, wherein each training sequence comprises a different phase rotation of the first training sequence.

17. The method of claim 16 wherein:
the second training sequence X₂ comprises a phase rotation of the first training sequence X₁ according to the relation: X₂=X₁e^{jπ};
a third training sequence X₃ comprises a phase rotation of the first training sequence X₁ according to the relation: X₃=X₁e^{jπ/2}; and
a fourth training sequence X₄ comprises a phase rotation of the first training sequence X₁ according to the relation: X₄=X₁e^{j3π/2}.

18. The method of claim 11 wherein the wireless communication system comprises an orthogonal frequency division multiplexing (OFDM) multiple input multiple output (MIMO) system.

19. The method of claim 18 wherein the first training sequence is transmitted over a first antenna, and the second training sequence is transmitted over a second antenna.

20. The method of claim 11 wherein the wireless communication system comprises an orthogonal frequency division multiplexing (OFDM) multiple input multiple output (MIMO) system having a transmitter with multiple antennas, such that the preamble is transmitted over a plurality of sub-carriers by multiple transmitter antennas, wherein each training sequence of the preamble is transmitted over a different one of the multiple antennas.

21. A method of channel estimation in a wireless OFDM-MIMO receiver, comprising the steps of:
receiving a data signal including one or more preambles from a transmitter, each preamble comprising a first training sequence, and a second training sequence, wherein the second training sequence comprises a phase rotation of the first training sequence; and
estimating the channel from the received preambles using a bank of linear filters.

22. The method of claim 21 wherein the transmitter includes Nt antennas and the receiver comprises Nᵣ antennas, forming NₜNᵣ channels.

23. The method of claim 22 wherein the filtering model for the linear bank of filters is according to:
$${Y}_{j} = {\sum }_{i = 1}^{{N}_{t}} {X}_{i} {H}_{ij} + {W}_{j} , j = 1 , 2 , … , {N}_{r} ,$$
wherein Xᵢ is the N×1 preamble vector from the i^{th} transmitter antenna, N is the number of OFDM data-subcarriers, Yⱼ is the received N×1 vector at the j^{th} receiver antenna, Hᵢⱼ is the channel response in frequency domain from iₜₕ transmitter antenna to j^{th} receiver antenna, and Wⱼ is the AWGN vector.

24. The method of claim 23 wherein the Hᵢⱼ channel response is estimated from Yⱼ, using linear filter coefficients Kᵢⱼ, such that the estimated channel response is Ĥᵢⱼ=KᵢⱼYⱼ.

25. The method of claim 24 wherein the channel is spatially uncorrelated.

26. The method of claim 25 wherein the filter coefficients Kᵢⱼ are according to relation:
$${K}_{i} = {R}_{{H}_{i} Y} {R}_{YY}^{- 1} = {R}_{{H}_{i} {H}_{i}} {{X}_{i}^{H} ( {\sum }_{l = 1}^{{N}_{t}} {X}_{l} {R}_{{H}_{l} {H}_{l}} {X}_{l}^{H} + {σ}_{W}^{2} I )}^{- 1} ,$$
where Kᵢⱼ=Kᵢ, j=1, . . . Nᵣ is the filter coefficient for the i^{th} transmitter antenna, R_{YY} is the autocorrelation matrix and R_{H}_{ᵢ}_{Y} is the cross-correlation matrix.

27. A wireless MIMO communication system, comprising:
a transmitter that transmits a data signal including at least one preamble comprising a first training sequence and a second training sequence, wherein the second training sequence comprises a phase rotation of the first training sequence, wherein the data signal is transmitted over a plurality of sub-carriers by multiple transmitter antennas; and
a receiver that receiver the transmitted signal including one or more preambles, the receiver including an estimator that estimates the channel from the received preambles using a bank of linear filters.

28. The system of claim 27 wherein said data signal comprises an orthogonal Frequency Division Multiplexing (OFDM) signal.

29. The system of claim 27 wherein said data signal comprises a plurality of frames, each frame including a plurality of time slots, each time slot including a plurality of symbols, wherein one or more preambles are inserted between the symbols within the frames in the time domain.

30. The system of claim 27 wherein the first training sequence comprises a 802.11a training sequence.

31. The system of claim 27 wherein the second training sequence X₂ comprises a phase rotation of the first training sequence X₁ according to the relation: X₂=X₁e^{jπ}.

32. The system of claim 27 where in the preamble further comprises multiple training sequences, wherein each training sequence comprises a different phase rotation of the first training sequence.

33. The system of claim 27 wherein the transmitter includes Nₜ antennas and the receiver comprises Nᵣ antennas, forming NₜNᵣ channels.

34. The system of claim 33 wherein the filtering model for the linear bank of filters is according to:
$${Y}_{j} = {\sum }_{i = 1}^{{N}_{t}} {X}_{i} {H}_{ij} + {W}_{j} , j = 1 , 2 , … , {N}_{r} ,$$
wherein Xᵢ is the N×1 preamble vector from the i^{th} transmitter antenna, N is the number of OFDM data-subcarriers, Yⱼ is the received N×1 vector at the j^{th} receiver antenna, Hᵢⱼ is the channel response in frequency domain from iₜₕ transmitter antenna to j^{th} receiver antenna, and Wⱼ is the AWGN vector.

35. The system of claim 34 wherein the Hᵢⱼ channel response is estimated from Yⱼ, using linear filter coefficients Kᵢⱼ, such that the estimated channel response is Ĥᵢⱼ=KᵢⱼYⱼ.
